(19) United States
(12) Patent Application Publication
(10) Pub. No.: US 2024/0241050 A1
(43) Pub. Date: Jul. 18, 2024

(54) EARLY FIRE DETECTION APPARATUS AND METHOD BASED ON UNWANTED ALARM PREVENTION FUNCTION

(71) Applicant: ELECTRONICS AND TELECOMMUNICATIONS RESEARCH INSTITUTE, Daejeon (KR)

(72) Inventors: Hoe-Sung YANG, Daejeon (KR); SOOCHEOL KIM, Daejeon (KR); Hyunseok KIM, Daejeon (KR); Jin Hwa RYU, Daejeon (KR); SO YUNG PARK, Daejeon (KR); KANG BOK LEE, Daejeon (KR); Yong Tae LEE, Daejeon (KR); Kwang-soo CHO, Daejeon (KR); Kyu Won HAN, Daejeon (KR)

(21) Appl. No.: 18/411,409

(22) Filed: Jan. 12, 2024

(30) Foreign Application Priority Data
Jan. 13, 2023 (KR) 10-2023-0005335

(51) Int. Cl. G01N 21/53

(52) U.S. Cl. CPC G01N 21/532; G01N 2201/126

(57) ABSTRACT

A fire detection method is provided. The fire detection method calculates a singular value for determining whether smoke penetrating into a chamber is caused by a fire or a non-fire by using the processor, based on n number of normalized values of scattered light and n number of normalized values of transmitted light.

### CROSS-REFERENCE TO RELATED APPLICATIONS

This application claims the benefit of the Korean Patent Application No. 10-2023-0005335 filed on Jan. 13, 2023, which is hereby incorporated by reference as if fully set forth herein.

### BACKGROUND

### Field of the Invention

The present invention relates to fire detection technology, and more particularly, to fire detection technology for preventing unwanted fire or false fire.

### Discussion of the Related Art

Fire detectors for detecting smoke may be categorized into ionization smoke (fire) detectors which measure a variation of an ion current value based on smoke and photoelectric smoke (fire) detectors which detect scattering of light caused by smoke particles. Also, there are ionization smoke (fire) detectors or aspirating smoke (fire) detectors which are a kind of photoelectric smoke detector and inhale air through a pipeline to early detect fire.

The photoelectric smoke detectors operate based on the principle that determines whether a signal strength of a light signal scattered by smoke particles flowing into an internal chamber is greater than a threshold value, and based thereon, issue a fire alarm. The photoelectric smoke detectors have a problem where the occurrence of a fire is determined even when fine particles instead of fire occur like cooking smoke, cigarette smoke, vapor, or fine dust occurring in daily life, in addition to real smoke, and thus, an unwanted alarm is frequently issued.

Because the aspirating smoke (fire) detectors are the same as the operation principle of general photoelectric smoke detectors and may quickly detect smoke with the principle that inhales air through a fan, the aspirating smoke (fire) detectors may early detect a fire and may prevent an unwanted alarm caused by dust by using a filter in an air inhalation process.

The aspirating smoke (fire) detectors are used for protecting expensive equipment such as semiconductor facilities from a fire, but recently, attempts to apply the aspirating smoke (fire) detectors to underground parking lots, elevator shafts, and a small space have been performed. Therefore, there is still a problem where an unwanted alarm occurs due to similar smoke occurring in daily life like cooking smoke, cigarette smoke, or vapor in addition to dust.

Due to a false alarm caused by an unwanted alarm, firefighters of a fire station may falsely dispatch to waste an administrative power, and persons may be insensitive to a case where a fire alarm is issued. Because there is a case where a fire receiver is not turned off for avoiding a false alarm, there is a severe problem where casualties and property damage occur because a fire detector does not operate when a real fire occurs.

### SUMMARY

An aspect of the present invention is directed to providing a fire detection apparatus and method which may differentiate smoke caused by the occurrence of a real fire from smoke occurring in daily life and may thus prevent an unwanted alarm.

A fire detection method according to an embodiment of the present invention includes: a step of detecting scattered light generated by smoke-based scattering of multi-wavelength light having n (where n is a natural number of 3 or more) number of wavelengths to obtain n number of measurement values of the n wavelengths by using a first light detector and detecting transmitted light, generated as the multi-wavelength light passes through the smoke, to obtain n number of measurement values of the n wavelengths by using a second light detector; a step of normalizing n number of measurement values of the scattered light to calculate n number of normalized values and normalizing n number of measurement values of the transmitted light to calculate n number of normalized values by using a processor; and a step of calculating a singular value for determining whether the smoke is caused by a fire or a non-fire by using the processor, based on the n normalized values of the scattered light and the n normalized values of the transmitted light.

A fire detection apparatus according to an embodiment of the present invention includes: a light emitter disposed in a chamber into which smoke penetrates and configured to emit multi-wavelength light having n (where n is a natural number of 3 or more) number of wavelengths; a first light detector disposed in the chamber and configured to detect scattered light generated by smoke-based scattering of the multi-wavelength light to obtain n number of measurement values of the n wavelengths; a second light detector disposed in the chamber and configured to detect transmitted light, generated as the multi-wavelength light passes through the smoke, to obtain n number of measurement values of the n wavelengths; and a processor configured to determine whether the smoke penetrating into the chamber is caused by a fire or a non-fire, based on the n normalized values of the scattered light and the n normalized values of the transmitted light.

In an embodiment, the processor normalizes n number of measurement values of the scattered light to calculate n number of normalized values, normalizes n number of measurement values of the transmitted light to calculate n number of normalized values, and determines whether the smoke penetrating into the chamber is caused by a fire or a non-fire, based on the n normalized values of the scattered light and the n normalized values of the transmitted light.

In an embodiment, the processor normalizes n number of measurement values of the scattered light to calculate n number of normalized values, normalizes n number of measurement values of the transmitted light to calculate n number of normalized values, and calculates a singular value for determining whether the smoke is caused by a fire or a non-fire, based on the n normalized values of the scattered light and the n normalized values of the transmitted light.

In an embodiment, the processor normalizes n number of measurement values of the scattered light to calculate n number of normalized values, normalizes n number of measurement values of the transmitted light to calculate n number of normalized values, calculates a first matrix including n×n number of elements representing a similarity between the n normalized values of the scattered light and a similarity between the n normalized values of the transmitted light, calculates a second matrix including n×n number of elements for calculating an optimal distribution of elements of the first matrix in each wavelength, and calculates an eigenvector of the second matrix as a singular value for determining whether the smoke is caused by a fire or a non-fire.

In an embodiment, the processor calculates the first matrix including the n×n elements representing a vector sum of a distance value representing a similarity between the n normalized values of the scattered light and a distance value representing a similarity between the n normalized values of the transmitted light.

In an embodiment, the eigenvector comprises n number of eigenvectors, and the processor analyzes a ratio of the n eigenvectors to determine whether the smoke is caused by a fire or a non-fire.

In an embodiment, the eigenvector comprises n number of eigenvectors, and the processor converts a ratio of the n eigenvectors into a plurality of angular values and analyzes a relationship between the plurality of angular values to determine whether the smoke is caused by a fire or a non-fire.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic configuration diagram of a photoelectric fire detector or an aspirating fire detector of the related art.

FIG. 2 is a diagram for describing a process where light emitted from a light emitting device is scattered by smoke and is input to a light detector in a situation where smoke is input to the inside of a chamber illustrated in FIG. 1.

FIG. 3 is a graph for describing an alarm issuing process of the photoelectric fire detector or the aspirating fire detector illustrated in FIG. 1.

FIG. 4 is a schematic configuration diagram of an early fire detection apparatus having an unwanted alarm prevention function according to an embodiment of the present invention.

FIG. 5 is a graph for describing an alarm issuing principle based on a first detection signal detected by a first multi-wavelength light detector and a second detection signal detected by a second multi-wavelength light detector illustrated in FIG. 4.

FIG. 6 is a graph showing n number of wavelengths included in multi-wavelength light generated by a multi-wavelength light emitter illustrated in FIG. 4.

FIG. 7 is a graph where outputs of four light emitting diodes (LEDs) are represented by I corresponding to each wavelength, in a case where the first multi-wavelength light detector illustrated in FIG. 4 is configured with the four LEDs.

FIG. 8A is a graph showing four normalized values “Norm A_{λ}” calculated by normalizing four measurement values obtained by detecting scattered light having each wavelength by using the first multi-wavelength light detector illustrated in FIG. 4.

FIG. 8B is a graph showing four normalized values “Norm B_{λ}” calculated by normalizing four measurement values obtained by detecting transmitted light having each wavelength by using the second multi-wavelength light detector illustrated in FIG. 4.

FIG. 9A is a graph showing Eₐ of Equation 2 according to an embodiment of the present invention.

FIG. 9B is a graph showing E_{b} of Equation 4 according to an embodiment of the present invention.

FIG. 10 is a diagram illustrating a geometric analysis of elements included in a matrix D of Equation 5 according to an embodiment of the present invention.

FIG. 11 is a diagram illustrating a geometric analysis of an optimal distribution of elements dᵢⱼ included in a matrix D in each wavelength calculated based on Equation 6 according to an embodiment of the present invention.

FIG. 12 is a graph showing eigenvectors of Equation 8 according to an embodiment of the present invention.

FIG. 13 is a graph showing Ang1, Ang2, and Ang3 of Equation 9 according to an embodiment of the present invention.

FIG. 14 is a flowchart for describing a fire detection method according to an embodiment of the present invention.

FIG. 15 is a block diagram of a computing device for implementing the fire detection method illustrated in FIG. 14.

### DETAILED DESCRIPTION OF THE INVENTION

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

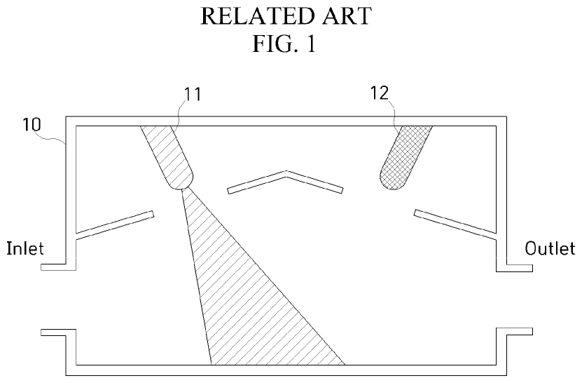

FIG. 1 is a schematic configuration diagram of a photoelectric fire detector or an aspirating fire detector of the related art.

Referring to FIG. 1, the photoelectric fire detector or the aspirating fire detector of the related art may include a chamber 10 which includes an inlet through which smoke penetrates and an outlet through which the penetrated smoke is discharged.

A light emitter 11 and a light detector 12 may be disposed in the chamber 10.

When light emitted from the light emitter 11 is input to the light detector 12, the fire detector may react. At this time, the light emitter 11 and the light detector 12 may be disposed to be staggered with each other so that the light emitted from the light emitter 11 is not input to the light detector 12 in a general environment where smoke particles do not flow in, and the light may be blocked by a light blocking wall.

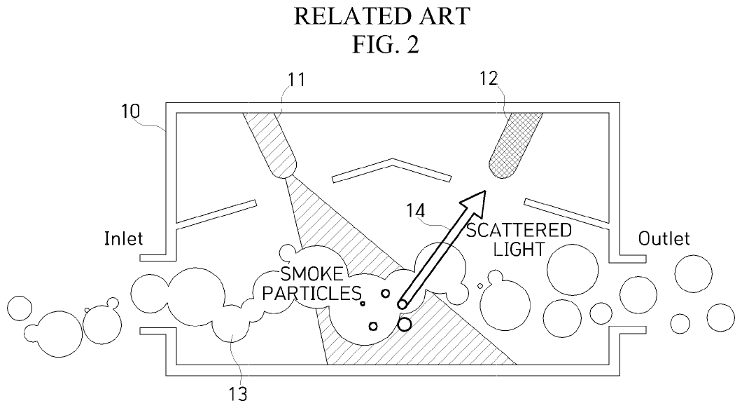

FIG. 2 is a diagram for describing a process where light emitted from a light emitting device is scattered by smoke and is input to a light detector in a situation where smoke is input to the inside of a chamber illustrated in FIG. 1.

Referring to FIG. 2, when smoke 13 penetrates into the chamber 10, light emitted from the light emitter 11 may be scattered by smoke particles of the smoke 13, light 14 scattered by the smoke particles may be input to the light detector 12, and the light detector 12 may detect the scattered light 14. In this case, a scattering phenomenon may occur due to fine dust irrelevant to a fire, cooking smoke, or cigarette smoke in addition to smoke particles caused by a fire. Here, the photoelectric fire detector or the aspirating fire detector may issue an unwanted alarm caused by an abnormal operation.

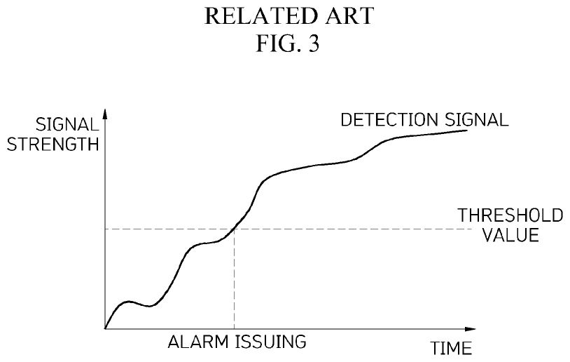

FIG. 3 is a graph for describing an alarm issuing process of the photoelectric fire detector or the aspirating fire detector illustrated in FIG. 1.

Referring to FIG. 3, the light detector 12 may detect light scattered by the smoke 13 penetrating into the chamber 10, and when a signal strength of a detection signal increases progressively and then reaches a threshold value which is set for issuing an alarm, the photoelectric fire detector or the aspirating fire detector may issue a fire alarm.

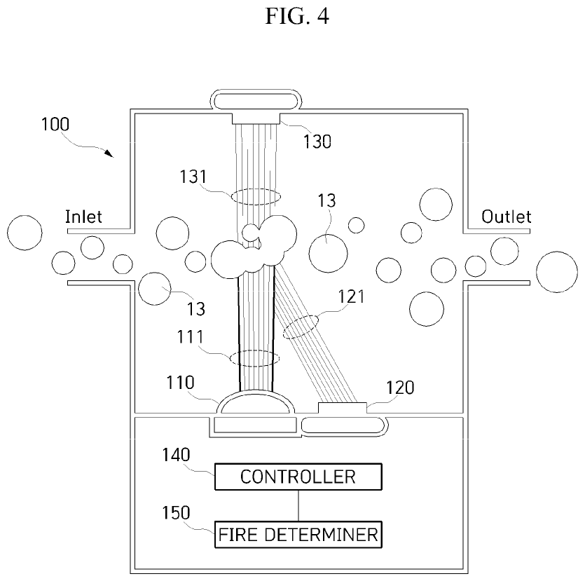

FIG. 4 is a schematic configuration diagram of an early fire detection apparatus having an unwanted alarm prevention function according to an embodiment of the present invention.

Referring to FIG. 4, the early fire detection apparatus 100 having an unwanted alarm prevention function according to an embodiment of the present invention may include a multi-wavelength light emitter 110 which emits multi-wavelength light 111 having a plurality of wavelengths, a first multi-wavelength light detector 120 which detects scattered light 121 occurring due to scattering of the multi-wavelength light 111 by smoke particles 13, and a second multi-wavelength light detector 130 which detects transmitted light 131 occurring when the multi-wavelength light 111 passes through the smoke particles 13.

Additionally, the early fire detection apparatus 100 may further include a controller 140 which controls and manages operations of the multi-wavelength light emitter 110, the first multi-wavelength light detector 120, and the second multi-wavelength light detector 130.

The controller 140 may control a turn-on/off operation of the multi-wavelength light emitter 110 and may control a detection operation of the first multi-wavelength light detector 120 and a detection operation of the second multi-wavelength light detector 130.

Moreover, the controller 140 may convert a signal strength of a scattered light signal (hereinafter referred to as a first detection signal) detected by the first multi-wavelength light detector 120 into digital data, convert a transmitted light signal (hereinafter referred to as a second detection signal) detected by the second multi-wavelength light detector 130 into digital data, and input the digital data to a fire determiner 150.

The fire determiner 150 may issue an alarm when smoke penetrating into the chamber occurs due to a real fire, based on an arithmetic operation result calculated by Equations described below.

Furthermore, arithmetic operations based on the below-described Equations may be performed by the controller 140 or the fire determiner 150. In this case, the controller 140 or the fire determiner 150 may be configured to include at least one of a microcontroller unit (MCU), a system on chip (SoC), a field programmable gate array (FPGA) chip, and the other semiconductor chip, which each include a processor and a memory.

In FIG. 4, the controller 140 and the fire determiner 150 are illustrated as independent elements which are apart from each other, but may be integrated into one element. For example, the controller 140 may be configured to include the fire determiner 150, or the fire determiner 150 may be configured to include the controller 140.

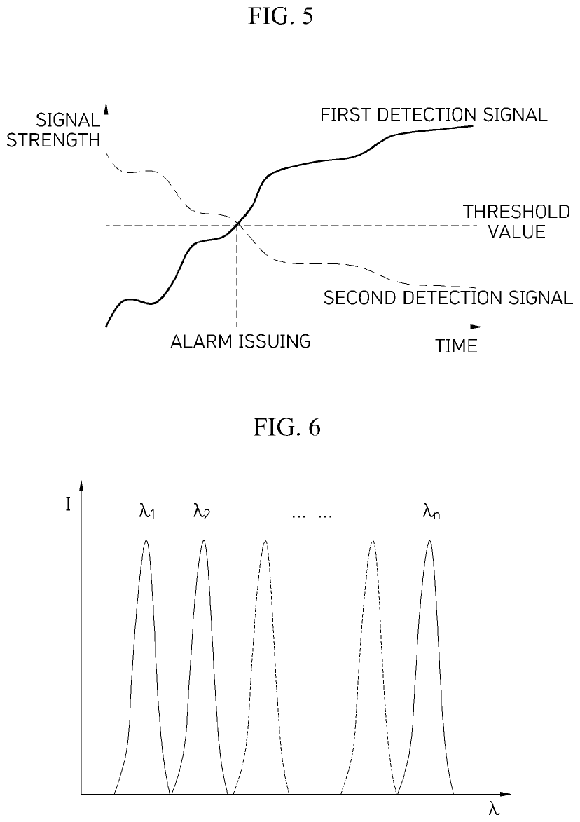

FIG. 5 is a graph for describing an alarm issuing principle based on a first detection signal detected by a first multi-wavelength light detector and a second detection signal detected by a second multi-wavelength light detector illustrated in FIG. 4.

Referring to FIG. 5, a first detection signal may correspond to a signal strength of scattered light detected (measured) by the first multi-wavelength light detector 120, and because the degree of scattering of multi-wavelength light (light source) increases progressively as the smoke particles 13 increase, a signal strength of the first detection signal may increase. A second detection signal may correspond to a signal strength of transmitted light detected (measured) by the second multi-wavelength light detector 130, and because the degree of transmission of multi-wavelength light (light source) increases progressively as the smoke particles 13 increase, a signal strength of the second detection signal may decrease. Here, a threshold value may be differently set based on the first detection signal and the second detection signal, so as to determine whether a fire based on a concentration of smoke occurs or not.

FIG. 6 is a graph showing n (where n may be an integer of one or more) number of wavelengths included in multi-wavelength light generated by a multi-wavelength light emitter illustrated in FIG. 4.

Referring to FIG. 6, a multi-wavelength light emitter (110 of FIG. 4) may include n number of LEDs or n number of laser sources. The n LEDs or the n laser sources may emit lights having different wavelengths. Accordingly, the multi-wavelength light may consist of n number of wavelength components “κ₁, λ₂, . . . , and λₙ”. Also, each of first and second multi-wavelength light detectors (120 and 130 of FIG. 4) may include a photodiode or a spectroscope. Here, n may be a natural number of 3 or more, and preferably, n may be a natural number of 4 or more.

In an embodiment of the present invention, it may be assumed that the multi-wavelength light emitter 110 is configured with four (n=4) light sources. In this case, a first wavelength “λ₁” may be 450 nm±50 nm, a second wavelength “λ₂” may be 550 nm±50 nm, a third wavelength “λ₃” may be 650 nm±50 nm, and a fourth wavelength “λ₄” may be 950 nm±50 nm.

Moreover, the first and second multi-wavelength light detectors 120 and 130 may respectively detect scattered light and transmitted light having a wavelength of 400 nm to 1000 nm. Here, the multi-wavelength light emitter 110 and the first multi-wavelength light detector 120 may be apart from each other and may be provided as independent elements, and moreover, may be integrated into one package.

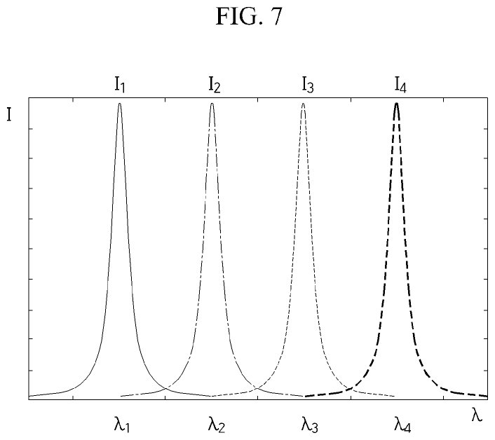

FIG. 7 is a graph where outputs of four LEDs are represented by I corresponding to each wavelength, in a case where the first multi-wavelength light detector illustrated in FIG. 4 is configured with the four LEDs.

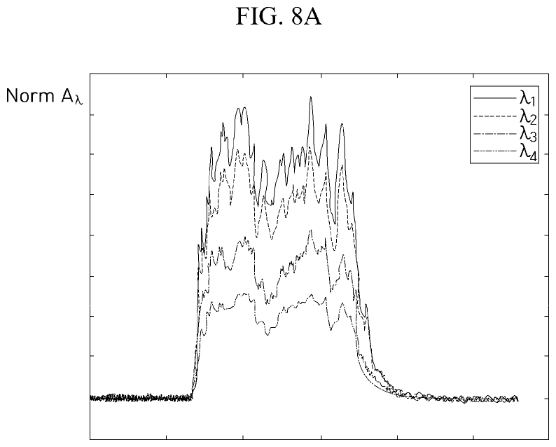

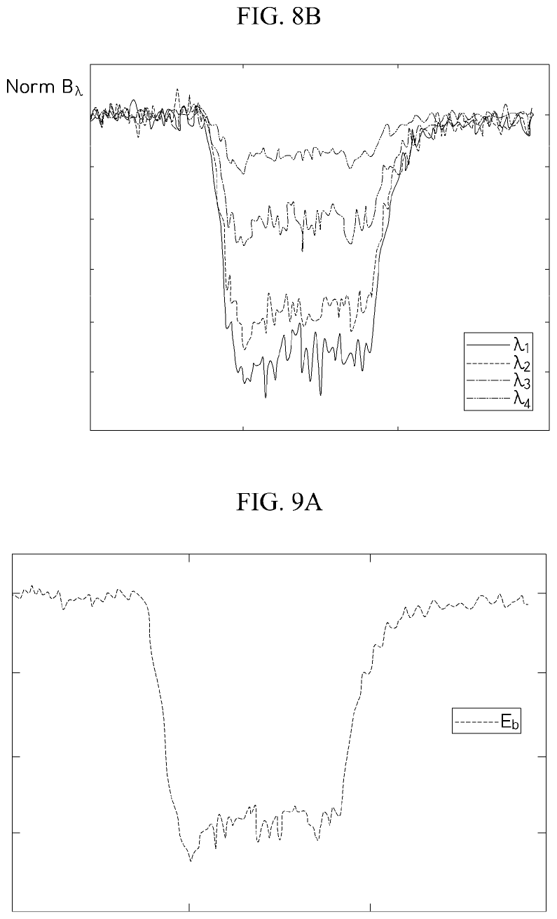

FIG. 8A is a graph showing four normalized values “Norm A_{λ}” calculated by normalizing four measurement values obtained by detecting scattered light having each wavelength by using the first multi-wavelength light detector illustrated in FIG. 4.

A normalized result value “Norm A_{λ}” shown in FIG. 8A may be obtained by normalizing a measurement value of light scattered by smoke particles by using the first multi-wavelength light detector 120 with respect to a measurement value obtained through measurement by the first multi-wavelength light detector 120 in a state where there are no smoke particles.

FIG. 8B is a graph showing four normalized values “Norm B_{λ}” calculated by normalizing four measurement values obtained by detecting transmitted light having each wavelength by using the second multi-wavelength light detector illustrated in FIG. 4.

A normalized result value “Norm B_{λ}” shown in FIG. 8B may be obtained by normalizing a measurement value of light passing through smoke particles by using the second multi-wavelength light detector 130 with respect to a measurement value obtained through measurement in a state where there are no smoke particles.

The normalized result value “Norm A_{λ}” shown in FIG. 8A may be represented by the following Equation 1.

$$Norm {A}_{λ} = [ \begin{matrix}Norm {A}_{1} \\ Norm {A}_{2} \\ Norm {A}_{3} \\ Norm {A}_{4}\end{matrix} ] \qquad [ Equation 1 ]$$

In Equation 1, a result value “Eₐ” obtained by summating Norm A₁, Norm A₂, Norm A₃, and Norm A₄ may be as expressed in the following Equation 2.

$${E}_{a} = \text{} {\sum }_{λ = 1}^{4} Norm {A}_{λ} = Norm {A}_{1} + Norm {A}_{2} + Norm {A}_{3} + Norm {A}_{4} \qquad [ Equation 2 ]$$

The normalized result value “Norm B_{λ}” shown in FIG. 8B may be represented by the following Equation 3.

$$Norm {B}_{λ} = [ \begin{matrix}Norm {B}_{1} \\ Norm {B}_{2} \\ Norm {B}_{3} \\ Norm {B}_{4}\end{matrix} ] \qquad [ Equation 3 ]$$

In Equation 3, a result value “E_{b}” obtained by summating Norm B₁, Norm B₂, Norm B₃, and Norm B₄ may be as expressed in the following Equation 4.

$${E}_{b} = \text{} {\sum }_{λ = 1}^{4} Norm {B}_{λ} = Norm {B}_{1} + Norm {B}_{2} + Norm {B}_{3} + Norm {B}_{4} \qquad [ Equation 4 ]$$

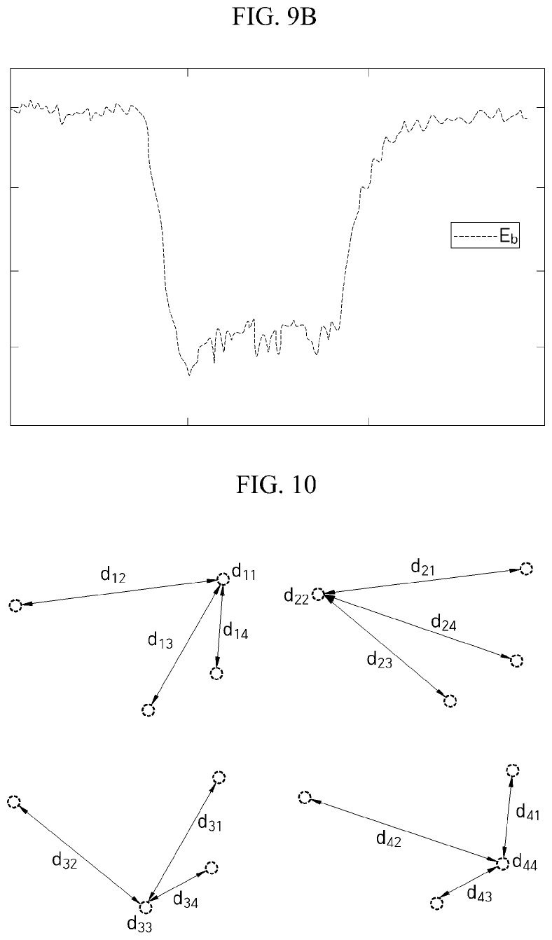

FIG. 9A is a graph showing Eₐ of Equation 2 according to an embodiment of the present invention, and FIG. 9B is a graph showing E_{b} of Equation 4 according to an embodiment of the present invention.

The normalized value “Norm A_{λ}” of Equation 1, Eₐ of Equation 2, the normalized value “Norm B_{λ}” of Equation 3, and E_{b} of Equation 4 may not provide sufficient information for determining whether smoke particles penetrating into the chamber occurs due to a fire or occurs due to a different cause other than a fire.

Therefore, in an embodiment of the present invention, the following mathematic algorithms for calculating a singular value for determining a fire or a non-fire on the basis of the normalized value “Norm A_{λ}” of Equation 1 and the normalized value “Norm B_{λ}” of Equation 3 may be provided.

First, the following Equation 5 for calculating a singular value may be provided.

$$D = [ \begin{matrix}{d}_{11} {d}_{12} {d}_{13} {d}_{14} \\ {d}_{21} {d}_{22} {d}_{23} {d}_{24} \\ {d}_{31} {d}_{32} {d}_{33} {d}_{34} \\ {d}_{41} {d}_{42} {d}_{43} {d}_{44}\end{matrix} ] \qquad [ Equation 5 ]$$

$${d}_{ij} = \sqrt{{( Norm {A}_{i} - Norm {A}_{j} )}^{2} + {( Norm {B}_{i} - Norm {B}_{j} )}^{2}} i , j = 1 , 2 , 3 , 4$$

In Equation 5, dᵢⱼ may be a distance value corresponding to a correlation (similarity) between elements of Equation 1 and Equation 3. That is, the matrix D may include n×n number of elements “dᵢⱼ” representing a similarity between n number of normalized values “Norm A_{λ}” of the scattered light and a similarity between n number of normalized values “Norm B_{λ}” of the transmitted light.

To provide a wide interpretation, the matrix D may include the n×n elements “dᵢⱼ” representing a vector sum of a distance value “Norm Aᵢ-Norm Aⱼ” representing a similarity between the n normalized values “Norm A_{λ}” of the scattered light and a distance value “Norm Bᵢ-Norm Bⱼ” representing a similarity between the n normalized values “Norm B_{λ}” of the transmitted light. To provide a wider interpretation, the matrix D may be defined as a matrix including elements representing a similarity between detection signals detected in four wavelengths (n=4). FIG. 10 is a diagram geometrically illustrating elements included in the matrix D.

$$S = [ \begin{matrix}{s}_{11} {s}_{12} {s}_{13} {s}_{14} \\ {s}_{21} {s}_{22} {s}_{23} {s}_{24} \\ {s}_{31} {s}_{32} {s}_{33} {s}_{34} \\ {s}_{41} {s}_{42} {s}_{43} {s}_{44}\end{matrix} ] \qquad [ Equation 6 ]$$

$${s}_{ij} = - \frac{1}{2} [ {d}_{ij}^{2} - \frac{1}{n} {\sum }_{q = 1}^{n} {d}_{iq}^{2} - \frac{1}{n} {\sum }_{p = 1}^{n} {d}_{pj}^{2} + \frac{1}{{n}^{2}} {\sum }_{g = 1}^{n} {\sum }_{h = 1}^{n} {d}_{gh}^{2} ]$$

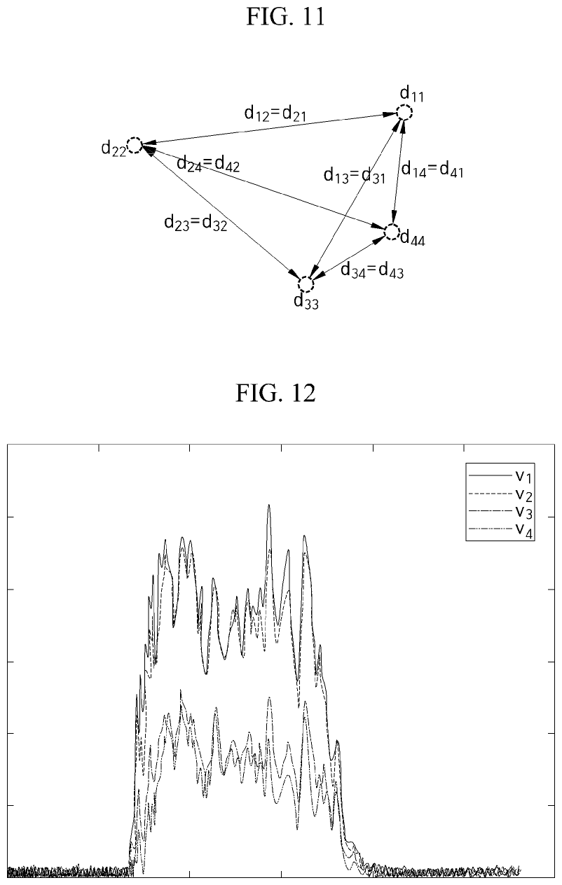

A matrix S of Equation 6 may be a matrix which uses, as an element, sᵢⱼ calculated by using each element value of the matrix D calculated as in Equation 5 in four wavelengths (n=4). To provide a wide interpretation, the matrix S may be defined as a matrix for calculating an optimal distribution of elements “dᵢⱼ” of the matrix D in each wavelength, based on a combination of the elements “dᵢⱼ” of the matrix D. FIG. 11 is a diagram for geometrically describing an optimal distribution of the elements dᵢⱼ of the matrix D calculated based on Equation 6 according to an embodiment of the present invention.

$$Sv = λ v \qquad [ Equation 7 ]$$

In Equation 7, λ may denote an eigenvalue of the matrix S of Equation 6, and v may denote an eigenvector corresponding to the eigenvalue “λ” of the matrix S. That is, in an n×n square matrix S, a column vector “v” which satisfies “Sv=λv” and is not 0 may be defined as an eigenvector, and a constant “k” may be defined as an eigenvalue.

The eigenvector may be represented by a matrix which includes four elements “v₁, v₂, v₃, and v₄” divided into four wavelengths as in Equation 8. The mathematic definition of the eigenvalue and the eigenvector may be widely known in linear algebra, and thus, a detailed description thereof is omitted.

$$v = [ \begin{matrix}{v}_{1} \\ {v}_{2} \\ {v}_{3} \\ {v}_{4}\end{matrix} ] \qquad [ Equation 8 ]$$

FIG. 12 is a graph showing eigenvectors of Equation 8 according to an embodiment of the present invention. In an embodiment of the present invention, a singular value may denote eigenvectors “v₁, v₂, v₃, and v₄” as in the graph of FIG. 12. In an embodiment of the present invention, because scattered light and transmitted light measured in each of four wavelengths are described for example, four eigenvectors may be calculated. Accordingly, n number of eigenvectors may be calculated in scattered light and transmitted light measured in each of n number of wavelengths.

To determine a fire and a non-fire on the basis of a combination of the scattered light and the transmitted light, in an embodiment of the present invention, the following equation for determining whether a fire occurs or not may be provided by combining the eigenvectors “v₁, v₂, v₃, and v₄” representing the singular value.

$$Ang 1 = {tan}^{- 1} ( \frac{{v}_{4}}{{v}_{1}} ) \qquad [ Equation 9 ]$$

$$Ang 2 = {tan}^{- 1} ( \frac{{v}_{4}}{{v}_{3}} )$$

$$Ang 3 = {tan}^{- 1} ( \frac{{v}_{2}}{{v}_{1}} )$$

$$⋮$$

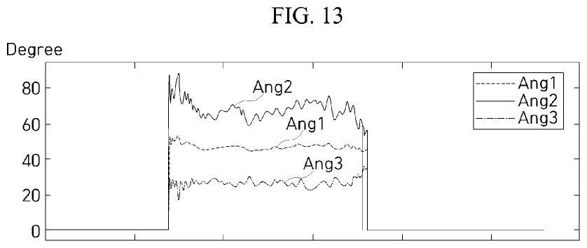

In Equation 9, each of Ang1, Ang2, and Ang3 may be a value which represents a ratio of the eigenvectors “v₁, v₂, v₃, and v₄” in an angular shape and may be shown by a graph as in FIG. 13.

An equation for determining the occurrence of a fire is not limited to Equation 9, and Equation 9 may be variously changed. For example, a result value obtained by summating or multiplying all of the singular values “v₁, v₂, v₃, and v₄” may be compared with a threshold value, and thus, whether a fire occurs or not may be determined. Alternatively, a similarity between the singular values “v₁, v₂, v₃, and v₄” may be calculated and may be compared with a threshold value, and thus, whether a fire occurs or not may be determined. Alternatively, a difference value between the singular values “v₁, v₂, v₃, and v₄” may be compared with a threshold value, and thus, whether a fire occurs or not may be determined. Alternatively, an average value of the singular values “v₁, v₂, v₃, and v₄” may be compared with a threshold value, and thus, whether a fire occurs or not may be determined.

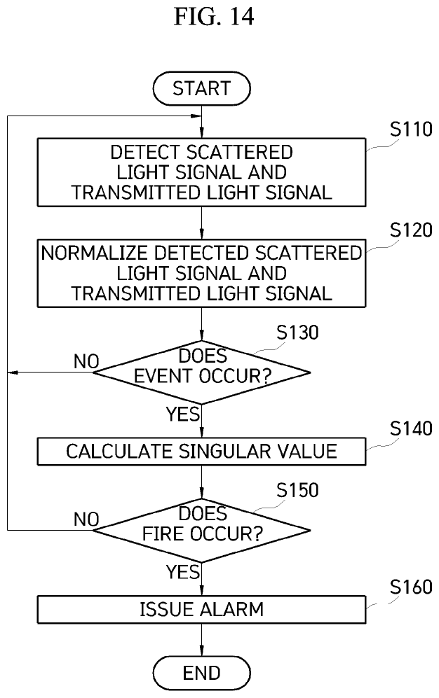

FIG. 14 is a flowchart for describing a method of determining a fire and a non-fire by calculating singular values corresponding to a scattered light signal and a transmitted light signal detected by an early fire detection apparatus having an unwanted alarm prevention function according to an embodiment of the present invention.

Referring to FIG. 14, first, at step S110, a process of detecting a scattered light signal and a transmitted light signal may be performed.

A process of detecting the scattered light signal may be a process of detecting scattered light generated by smoke-based scattering of multi-wavelength light emitted from the light emitter 110 to obtain n number of measurement values “A_{λ}” of the n wavelengths by using the first light detector 120. Here, the multi-wavelength light may be light having n (where n may be a natural number of 3 or more) number of wavelengths.

A process of detecting the transmitted light signal may be a process of detecting transmitted light, generated as the multi-wavelength light passes through the smoke, to obtain n number of measurement values “B_{λ}” of the n wavelengths by using the second light detector 130.

Subsequently, at step S120, a process of normalizing the detected scattered light signal and transmitted light signal may be performed. Such a normalization process may be performed by the controller 140 or the fire determiner 150 illustrated in FIG. 4, an element where the controller 140 and the fire determiner 150 are integrated as one element, a processor included in the integrated element, or a computing device which controls operations of the controller 140 and the fire determiner 150. Hereinafter, it may be assumed that the normalization process is performed by the processor.

A normalization process on the scattered light signal may be a process of normalizing n number of measurement values of the scattered light to calculate n number of normalized values “Norm A_{λ}” (Equation 1). A normalization process on the transmitted light signal may be a process of normalizing n number of measurement values of the transmitted light to calculate n number of normalized values “Norm B_{λ}” (Equation 3).

Subsequently, at step S130, a process of detecting the occurrence of an event estimated as a fire in the processor may be performed.

A process of detecting the occurrence of the event may be performed based on at least one of a sum value (Eₐ of Equation 2) of the n normalized values “Norm A_{λ}” of the scattered light and a sum value (E_{b} of Equation 4) of the n measurement values of the transmitted light.

For example, when the sum value (Eₐ of Equation 2) is greater than a predetermined threshold value and the sum value (E_{b} of Equation 4) is greater than the threshold value, it may be determined that the event estimated as a fire occurs. In this case, the threshold value compared with the sum value (Eₐ of Equation 2) may be equal to or different from the threshold value compared with the sum value (E_{b} of Equation 4).

As another example, when all of the sum value (Eₐ of Equation 2) and the sum value (E_{b} of Equation 4) are greater than the threshold value, it may be determined that the event estimated as a fire occurs.

When it is determined that the event estimated as a fire does not occur, step S140 may not be performed, and steps S110 to S130 may be repeated and performed.

Subsequently, at step S140, a process of calculating a singular value (v of Equation 8) on the n normalized values “Norm A_{λ}” of the scattered light and the normalized values “Norm B_{λ}” of the transmitted light by using the processor may be performed. Here, the singular value “v” may be data for determining whether the smoke is caused by a fire or a non-fire.

Subsequently, at step S150, a process of determining whether a fire occurs or not on the basis of the calculated singular value “v” by using the processor may be performed. When it is determined that smoke penetrating into the chamber is caused by a fire, based on an analysis of the singular value “v”, step S160 may be performed, and at step S160, the fire detection apparatus 100 may output alarm information indicating the occurrence of a fire. Here, the alarm information may be output as visual or/and acoustical information. Also, the fire detection apparatus 100 may not directly output the alarm information and may transfer an electrical signal corresponding to the alarm information to a fire receiver installed outside the fire detection apparatus 100, and the fire receiver may issue an alarm corresponding to the electrical signal.

Moreover, at step S150, when it is determined that the smoke penetrating into the chamber is caused by a non-fire, based on an analysis of the singular value “v”, steps S110 to S140 may be repeated and performed.

In an embodiment, a process of calculating the singular value “v” may include a process of calculating a first matrix (D of Equation 5) including n×n number of elements “dᵢⱼ” representing a similarity between the n normalized values “Norm A_{λ}” of the scattered light and a similarity between the n normalized values “Norm B_{λ}” of the transmitted light, a process of calculating a second matrix (S of Equation 6) including n×n number of elements “sᵢⱼ” for calculating an optimal distribution of similarities between wavelengths on the basis of a combination of elements of the first matrix, and a process of calculating an eigenvector “v” of the second matrix S. Here, the eigenvector “v” may be the singular value “v”.

In an embodiment, the first matrix (D of Equation 5) may include the n×n elements “dᵢⱼ” representing a sum of a distance value “Norm Aᵢ-Norm Aⱼ” representing a similarity between the n normalized values “Norm A_{λ}” of the scattered light and a distance value “Norm Bᵢ-Norm Bⱼ” representing a similarity between the n normalized values “Norm B_{λ}” of the transmitted light.

In an embodiment, the eigenvector “v” may include n number of eigenvectors, and step S140 may further include a step of analyzing a ratio (for example, v₄/v₁, v₄/v₃, and v₂/v₁ of Equation 9) of the n eigenvectors (for example, v₁, v₂, v₃, and v₄ of Equation 8) to determine whether the smoke is caused by a fire or a non-fire.

In an embodiment, the eigenvector “v” may include n number of eigenvectors, and step S140 may include a step of converting a ratio of the n eigenvectors into a plurality of angular values (for example, Ang1, Ang2, and Ang3 of Equation 9) and a step of analyzing a relationship between the plurality of angular values (for example, Ang1, Ang2, and Ang3 of Equation 9) to determine whether the smoke is caused by a fire or a non-fire. Here, whether the smoke is caused by a fire or a non-fire may be determined based on a relationship analysis and a combination between the plurality of angular values (for example, Ang1, Ang2, and Ang3 of Equation 9). Also, whether the smoke is caused by a fire or a non-fire may be determined based on a relationship analysis and a combination between difference values (for example, Ang1-Ang2, Ang2-Ang3, or Ang1-Ang3) between the plurality of angular values. Also, whether the smoke is caused by a fire or a non-fire may be determined based on a similarity between the plurality of angular values (for example, Ang1, Ang2, and Ang3 of Equation 9).

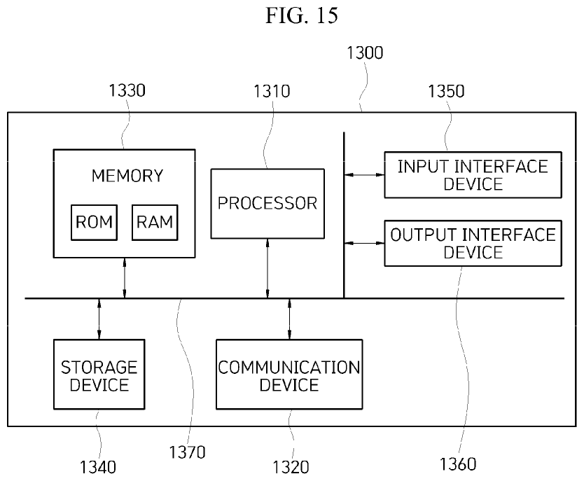

FIG. 15 is a block diagram of a computing device 1300 for implementing a fire detection method according to an embodiment of the present invention.

Referring to FIG. 15, the computing device 1300 may include at least one of a processor 1310, a memory 1330, an input interface device 1350, an output interface device 1360, and a storage device 1340, which communicate with one another through a bus 1370. The computing system 1300 may include a communication device 1320 coupled to a network.

The communication device 1320 may be configured to include known communication elements for supporting wired/wireless Internet, 3G, LTE, 4G, 5G, Public Safety-LTE (PS-LTE), WiFi, Bluetooth, and wireless communication for fire detection. The communication device 1320 may transmit a fire determination result, determined by the processor 1310, to an external device by using wired or wireless communication.

The processor 1310 may be a central processing unit (CPU), a graphics processing unit (GPU), a microcontroller unit (MCU), a field programmable gate array (FPGA) chip, or a system on chip (SoC), or may be a semiconductor device which executes an instruction stored in the memory 1330 or the storage device 1340.

Moreover, the processor 1310 may control operations of the light emitter 110 and the first and second light detectors 120 and 130 for performing step S110 of FIG. 14. Also, the processor 1310 may process operations of steps S120 to S150 illustrated in FIG. 14.

The memory 1330 and the storage device 1340 may include various types of volatile or non-volatile storage mediums. For example, the memory 1330 may include read only memory (ROM) and random access memory (RAM). In an embodiment of the present invention, the memory 1330 may be disposed in or outside the processor 1310 and may be connected with the processor 1310 through various means known to those skilled in the art.

The memory 1330 may temporarily store various instructions for performing steps S110 to S150 illustrated in FIG. 14.

The storage device 1340 may store various programs for performing steps S110 to S150 illustrated in FIG. 14.

The input interface device 1350 may be a key input device which receives various user commands for controlling an operation of the fire detection apparatus 100.

The output interface device 1360 may include a display device which outputs a fire alarm, converts the fire alarm into visual information, and displays the visual information, based on control by the processor 1310, and a speaker which converts the fire alarm into acoustical information and outputs the acoustical information.

An embodiment of the present invention may be implemented as a method implemented in a computer, or may be implemented as a non-transitory computer-readable medium storing a computer-executable instruction. In an embodiment, when executed by the processor, the computer-readable instruction may perform a method according to at least one aspect of the present invention. Also, the method according to an embodiment of the present invention may be implemented as a program instruction type capable of being performed by various computer means and may be stored in a computer-readable recording medium. The computer-readable recording medium may include a program instruction, a data file, or a data structure, or a combination thereof. The program instruction recorded in the computer-readable recording medium may be specially designed for an embodiment of the present invention, or may be known to those skilled in the computer software art and may be used. The computer-readable recording medium may store may include a hardware device which stores and executes the program instruction. For example, the computer-readable recording medium may be a magnetic media such as a hard disk, a floppy disk, and a magnetic tape, an optical media such as CD-ROM or DVD, a magneto-optical media such as a floptical disk, ROM, RAM, or flash memory. The program instruction may include a high-level language code executable by a computer such as an interpreter, in addition to a machine language code such as being generated by a compiler.

According to the embodiments of the present invention, a characteristic where the degrees of scattering and transmission of light having a multi-wavelength are changed by smoke particles and a singular value of the characteristic may be calculated based on a mathematic algorithm, and a fire and a false fire may be accurately differentiated from each other by analyzing the calculated singular value. Accordingly, the false dispatch of firefighters caused by a false fire alarm may be prevented, and the reliability of a fire alarm on persons may increase.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A fire detection method comprising:
a step of detecting scattered light generated by smoke-based scattering of multi-wavelength light having n (where n is a natural number of 3 or more) number of wavelengths to obtain n number of measurement values of the n wavelengths by using a first light detector and detecting transmitted light, generated as the multi-wavelength light passes through the smoke, to obtain n number of measurement values of the n wavelengths by using a second light detector;
a step of normalizing n number of measurement values of the scattered light to calculate n number of normalized values and normalizing n number of measurement values of the transmitted light to calculate n number of normalized values by using a processor; and
a step of calculating a singular value for determining whether the smoke is caused by a fire or a non-fire by using the processor, based on the n normalized values of the scattered light and the n normalized values of the transmitted light.

2. The fire detection method of claim 1, wherein the step of calculating the singular value comprises:
a step of detecting occurrence of an event estimated as a fire, based on at least one of a sum value of the n normalized values of the scattered light and a sum value of the n measurement values of the transmitted light; and
a step of calculating the singular value when the occurrence of the event is detected.

3. The fire detection method of claim 2, wherein the step of detecting the occurrence of the event comprises a step of detecting the occurrence of the event, based on a comparison result obtained by comparing the at least one sum value with a threshold value.

4. The fire detection method of claim 1, wherein the step of calculating the singular value comprises:
a step of calculating a first matrix including n×n number of elements representing a similarity between the n normalized values of the scattered light and a similarity between the n normalized values of the transmitted light;
a step of calculating a second matrix including n×n number of elements for calculating an optimal distribution of elements of the first matrix in each wavelength; and
a step of calculating an eigenvector of the second matrix as the singular value.

5. The fire detection method of claim 4, wherein the first matrix comprises the n×n elements representing a vector sum of a distance value representing a similarity between the n normalized values of the scattered light and a distance value representing a similarity between the n normalized values of the transmitted light.

6. The fire detection method of claim 4, wherein the eigenvector comprises n number of eigenvectors, and the fire detection method further comprises a step of analyzing a ratio of the n eigenvectors to determine whether the smoke is caused by a fire or a non-fire.

7. The fire detection method of claim 4, wherein the eigenvector comprises n number of eigenvectors, and
the fire detection method further comprises:
a step of converting the ratio of the n eigenvectors into a plurality of angular values; and
a step of analyzing a relationship between the plurality of angular values to determine whether the smoke is caused by a fire or a non-fire.

8. A fire detection apparatus comprising:
a light emitter disposed in a chamber into which smoke penetrates and configured to emit multi-wavelength light having n (where n is a natural number of 3 or more) number of wavelengths;
a first light detector disposed in the chamber and configured to detect scattered light generated by smoke-based scattering of the multi-wavelength light to obtain n number of measurement values of the n wavelengths;
a second light detector disposed in the chamber and configured to detect transmitted light, generated as the multi-wavelength light passes through the smoke, to obtain n number of measurement values of the n wavelengths; and
a processor configured to determine whether the smoke penetrating into the chamber is caused by a fire or a non-fire, based on the n normalized values of the scattered light and the n normalized values of the transmitted light.

9. The fire detection apparatus of claim 8, wherein the processor normalizes n number of measurement values of the scattered light to calculate n number of normalized values, normalizes n number of measurement values of the transmitted light to calculate n number of normalized values, and determines whether the smoke penetrating into the chamber is caused by a fire or a non-fire, based on the n normalized values of the scattered light and the n normalized values of the transmitted light.

10. The fire detection apparatus of claim 8, wherein the processor normalizes n number of measurement values of the scattered light to calculate n number of normalized values, normalizes n number of measurement values of the transmitted light to calculate n number of normalized values, and calculates a singular value for determining whether the smoke is caused by a fire or a non-fire, based on the n normalized values of the scattered light and the n normalized values of the transmitted light.

11. The fire detection apparatus of claim 8, wherein the processor normalizes n number of measurement values of the scattered light to calculate n number of normalized values, normalizes n number of measurement values of the transmitted light to calculate n number of normalized values, calculates a first matrix including n×n number of elements representing a similarity between the n normalized values of the scattered light and a similarity between the n normalized values of the transmitted light, calculates a second matrix including n×n number of elements for calculating an optimal distribution of elements of the first matrix in each wavelength, and calculates an eigenvector of the second matrix as a singular value for determining whether the smoke is caused by a fire or a non-fire.

12. The fire detection apparatus of claim 11, wherein the processor calculates the first matrix including the n×n elements representing a vector sum of a distance value representing a similarity between the n normalized values of the scattered light and a distance value representing a similarity between the n normalized values of the transmitted light.

13. The fire detection apparatus of claim 11, wherein the eigenvector comprises n number of eigenvectors, and
the processor analyzes a ratio of the n eigenvectors to determine whether the smoke is caused by a fire or a non-fire.

14. The fire detection apparatus of claim 11, wherein the eigenvector comprises n number of eigenvectors, and
the processor converts a ratio of the n eigenvectors into a plurality of angular values and analyzes a relationship between the plurality of angular values to determine whether the smoke is caused by a fire or a non-fire.
